(19) United States
(12) Patent Application Publication
(10) Pub. No.: US 2025/0149248 A1
(43) Pub. Date: May 8, 2025

(54) ELECTRONIC COMPONENT THAT SUPPRESSES MIGRATION IN EXTERNAL ELECTODES

(71) Applicant: Murata Manufacturing Co., Ltd., Nagaokakyo-shi (JP)

(72) Inventors: Noriyuki OOKAWA, Nagaokakyo-shi (JP); Toshihiko KOBAYASHI, Nagaokakyo-shi (JP); Tomochika MIYAZAKI, Nagaokakyo-shi (JP)

(73) Assignee: Murata Manufacturing Co., Ltd., Nagaokakyo-shi (JP)

(21) Appl. No.: 19/017,840

(22) Filed: Jan. 13, 2025

Related U.S. Application Data
(63) Continuation of application No. PCT/JP2024/000441, filed on Jan. 11, 2024.

(30) Foreign Application Priority Data
Jun. 14, 2023 (JP) 2023-098070

(51) Int. Cl. H01G 4/232; H01G 4/30

(52) U.S. Cl. CPC H01G 4/2325; H01G 4/30

(57) ABSTRACT

An electronic component includes a base body, and a first internal electrode and a second internal electrode located inside the base body. In addition, the electronic component includes a first external electrode and a second external electrode that cover a part of the outer surface of the base body and do not contain a silver component. The first external electrode includes a first electrode covering a part of the outer surface of the base body and connected to the first internal electrode, and a second electrode covering the outer surface of the first electrode. The second electrode contains copper particles and a silicone resin as a synthetic resin. When viewed in a specific section including the first electrode and the second electrode, the copper particles of the second electrode are in line contact with the outer surface of the first electrode.

### CROSS-REFERENCE TO RELATED APPLICATIONS

This application is a continuation of international application no. PCT/JP2024/000441, filed Jan. 11, 2024, and which claims priority to Japanese application no. 2023-098070, filed Jun. 14, 2023. The entire contents of both prior applications are hereby incorporated by reference.

### TECHNICAL FIELD

The present disclosure relates to an electronic component.

### BACKGROUND ART

A conventional electronic component may include a base body, an internal electrode, and an external electrode. The internal electrode is located inside the base body. The external electrode includes a base layer, a first plating layer, and a conductive resin layer. The base layer covers a part of the outer surface of the base body. The base layer contains metal as a main component and contains a glass component. The first plating layer is located on the outer surface side of the base layer. The first plating layer is made of copper. The conductive resin layer is located on the outer surface side of the first plating layer. The conductive resin layer is a resin layer containing silver. In addition, the electronic component has an organic compound having water repellency on the outer surface thereof.

### SUMMARY

### Problem to be Solved

In the electronic component described above, the conductive resin layer contains a silver component. In a high-temperature and high-humidity environment, silver contained in the conductive resin layer is more likely to be eluted, and therefore migration may occur. In this regard, the electronic component described above has an organic compound having water repellency on the surface thereof. Therefore, in the electronic component, it is possible to suppress adhesion of moisture to the surface of the electronic component, and thus the occurrence of migration of silver. Nevertheless, when it is attempted to provide such an organic compound layer, there is a possibility that the manufacturing process becomes complicated. In addition, the presence of such an organic compound layer may cause adverse effects. Therefore, a technique capable of suppressing migration of an external electrode without requiring an additional layer such as the organic compound layer of the electronic component described above is required.

### Exemplary Solution to the Problem

In order to solve the above problems, one aspect of the present disclosure is an electronic component including a base body, an internal electrode located inside the base body, and an external electrode covering a part of an outer surface of the base body and containing no silver component. The external electrode includes a first electrode covering a part of an outer surface of the base body and connected to the internal electrode, and a second electrode covering an outer surface of the first electrode. The second electrode contains a copper particle and a synthetic resin, and when viewed in a specific section including the first electrode and the second electrode, the copper particle of the second electrode is in line contact with an outer surface of the first electrode.

### Advantageous Effects

According to the configuration mentioned above, since the external electrode does not have a silver component, migration can be suppressed from occurring in the external electrode.

### BRIEF EXPLANATION OF DRAWINGS

FIG. 1 is a perspective view of an electronic component.

FIG. 2 is a side view of the electronic component.

FIG. 3 is a sectional view taken along line 3-3 in FIG. 2.

FIG. 4 is a sectional view of a specific section of the electronic component.

FIG. 5 is a schematic view in which a part of FIG. 4 is enlarged.

FIG. 6 is a flowchart to outline a method of manufacturing an electronic component.

### DETAILED DESCRIPTION

Hereinafter, an exemplary embodiment of the electronic component will be described with reference to the drawings. In the drawings, sometimes a component is illustrated while enlarged for the sake of easy understanding. In some cases, the dimension ratio of a component differs from an actual dimension ratio or a dimension ratio in another drawing.

### Overall Configuration of Electronic Component

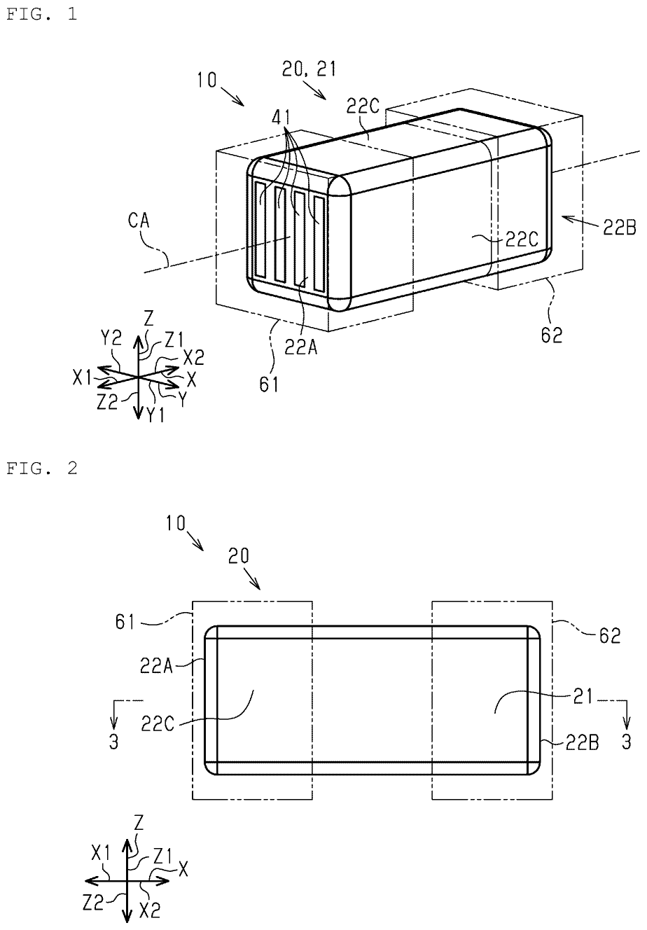

As illustrated in FIG. 1, the electronic component 10 is a multilayer ceramic capacitor. The electronic component 10 includes a base body 20. The base body 20 has a substantially quadrangular prism shape and has a central axis CA. Hereinafter, an axis extending along the central axis CA is referred to as a first axis X. One of the axes orthogonal to the first axis X is defined as a second axis Y. Further, an axis that is orthogonal to both the first axis X and the second axis Y is defined as a third axis Z. In addition, one of the directions along the first axis X is defined as a first positive direction X1, and the direction opposite to the first positive direction X1, of the directions along the first axis X, is defined as a first negative direction X2. In addition, one of the directions along the second axis Y is defined as a second positive direction Y1, and the direction opposite to the second positive direction Y1, of the directions along the second axis Y, is defined as a second negative direction Y2. Further, one of the directions along the third axis Z is defined as a third positive direction Z1, and a direction opposite to the third positive direction Z1, of the directions along the third axis Z, is defined as a third negative direction Z2.

An outer surface 21 of the base body 20 has six planes. The term “surface” of the base body 20 as used herein refers to a part that can be observed as a surface when the entire base body 20 is observed. More specifically, for example, when there are such minute irregularities or steps that fail to be found unless a part of the base body 20 is enlarged and then observed with a microscope or the like, the surface is expressed as a plane or a curved surface. The six planes face different directions. The six planes are roughly divided into a first end surface 22A facing the first positive direction X1, a second end surface 22B facing the first negative direction X2, and four side surfaces 22C. The four side surfaces 22C are a surface facing the third positive direction Z1, a surface facing the third negative direction Z2, a surface facing the second positive direction Y1, and a surface facing the second negative direction Y2, respectively.

In the outer surface 21 of the base body 20, a boundary portion between two adjacent planes and a boundary portion between three adjacent surfaces are curved surfaces. That is, the corners of the base body 20 are round chamfered.

As illustrated in FIGS. 1 and 2, in the base body 20, the dimension in the direction along the first axis X is larger than the dimension in the direction along the third axis Z and the dimension in the direction along the second axis Y. The material of the base body 20 is a dielectric ceramic. Specifically, the material of the base body 20 contains BaTiO₃ as a main component. Alternatively, the material of the base body 20 may contain CaTio₃, SrTiO₃, CaZrO₃, or the like as a main component. In addition, the material of the base body 20 may contain a Mn compound, a Co compound, a Si compound, a rare earth compound, or the like as an accessory component.

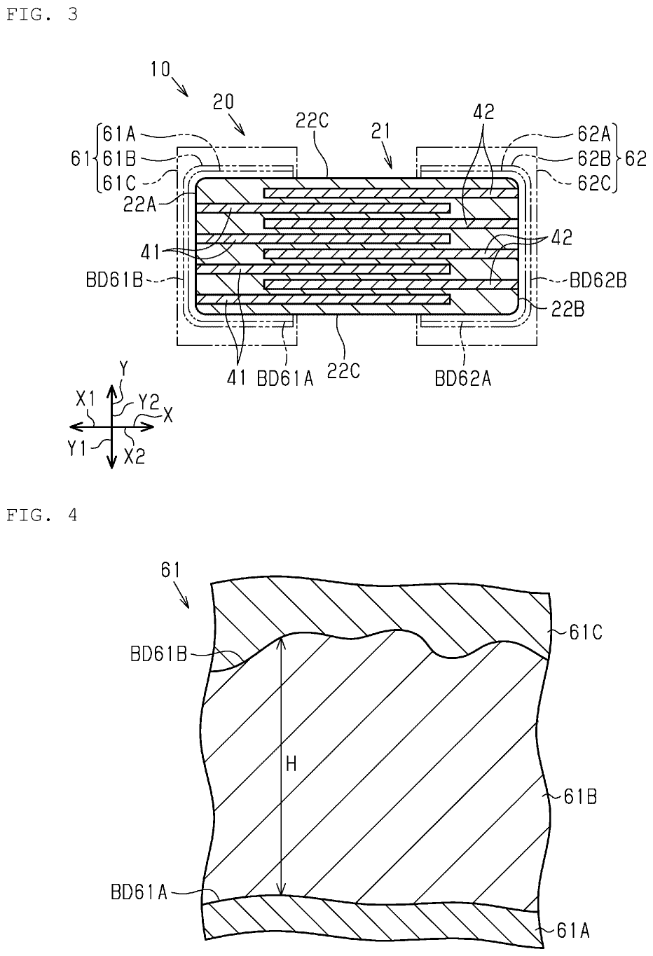

As illustrated in FIG. 3, the electronic component 10 includes four first internal electrodes 41 and four second internal electrodes 42. The first internal electrode 41 and the second internal electrode 42 are located inside the base body 20.

The material of the first internal electrode 41 is a conductive material. For example, the material of the first internal electrodes 41 is Ni. In addition, the material of the first internal electrode 41 may further contain metals such as Ni, Cu, Ag, Au, Pt, Sn, and Pd, or alloys containing these metals. The material of the second internal electrodes 42 is the same as the material of the first internal electrodes 41.

The first internal electrode 41 has a rectangular plate shape. The first internal electrode 41 has a principal surface orthogonal to the second axis Y. The second internal electrode 42 has the same rectangular plate shape as the first internal electrode 41. The second internal electrode 42 has a principal surface orthogonal to the second axis Y, as with the first internal electrode 41.

The dimension of the first internal electrode 41 in the direction along the first axis X is smaller than the dimension of the base body 20 in the direction along the first axis X. As illustrated in FIG. 1, the dimension of the first internal electrode 41 in the direction along the third axis Z is approximately ⅔ of the dimension of the base body 20 in the direction along the third axis Z. The dimension of the second internal electrode 42 in each of the directions is the same as that of the first internal electrode 41.

As illustrated in FIG. 3, the first internal electrodes 41 and the second internal electrodes 42 are located in a staggered manner in the direction along the second axis Y. More specifically, a total of eight internal electrodes are arranged alternately in the order of the first internal electrode 41 and the second internal electrode 42 toward the second negative direction Y2 from the side surface 22C that faces in the second positive direction Y1. According to the exemplary embodiment, each of the internal electrodes has an equal distance therebetween in the direction along the second axis Y.

As illustrated in FIG. 1, the four first internal electrodes 41 and the four second internal electrodes 42 are both located at the center of the base body 20 in the direction along the third axis Z. On the other hand, as illustrated in FIG. 3, the first internal electrodes 41 are located deviated to the first positive direction X1. The second internal electrodes 42 are located deviated to the first negative direction X2.

Specifically, an end of the first internal electrode 41 on the first positive direction X1 side substantially coincides with an end of the base body 20 on the first positive direction X1 side. Therefore, the end of the first internal electrode 41 on the first positive direction X1 side is exposed from the first end surface 22A of the base body 20. The end of the first internal electrode 41 on the first negative direction X2 side is located inside the base body 20 and does not reach the end of the base body 20 on the first negative direction X2 side. On the other hand, an end of the second internal electrode 42 on the first negative direction X2 side substantially coincides with an end of the base body 20 on the first negative direction X2 side. Therefore, the end of the second internal electrode 42 on the first negative direction X2 side is exposed from the second end surface 22B of the base body 20. The end of the second internal electrode 42 on the first positive direction X1 side is located inside the base body 20 and does not reach the end of the base body 20 on the first positive direction X1 side.

As illustrated in FIG. 3, the electronic component 10 includes a first external electrode 61 and a second external electrode 62. The first external electrode 61 and the second external electrode 62 are conductive as a whole. On the other hand, the first external electrode 61 and the second external electrode 62 contain no silver component. Here, “contains no silver component” allows a slight amount of silver component to be mixed into each external electrode in the manufacturing process. For example, when the atomic percent of the silver atom to all the atoms constituting each external electrode is less than 1 atm %, it is considered as “the external electrode contains no silver component”. This is because when the atomic percent of the silver atom is less than 1 atm %, significant migration that affects the characteristics of the electronic component 10 does not occur.

The first external electrode 61 includes a first electrode 61A, a second electrode 61B, and a third electrode 61C.

The first electrode 61A covers a part of the outer surface 21 of the base body 20. Specifically, the first electrode 61A covers the first end surface 22A of the base body 20 and parts of the four side surfaces 22C thereof on the first positive direction X1 side. The first electrode 61A is connected to the first internal electrode 41 exposed from the first end surface 22A. The first electrode 61A contains a copper component and a trace amount of glass.

The second electrode 61B covers the outer surface BD61A of the first electrode 61A. That is, the second electrode 61B is laminated on the first electrode 61A. Details of the second electrode 61B will be described later.

The third electrode 61C covers the outer surface BD61B of the second electrode 61B. A part of the third electrode 61C protrudes from the second electrode 61B. Although not illustrated in the drawing, the third electrode 61C has a two-layer structure of a nickel layer and a tin layer in this order from the second electrode 61B side.

The second external electrode 62 includes a first electrode 62A, a second electrode 62B, and a third electrode 62C.

The first electrode 62A covers a part of the outer surface 21 of the base body 20. Specifically, the first electrode 62A covers the second end surface 22B of the base body 20 and parts of the four side surfaces 22C thereof on the first negative direction X2 side. The first electrode 62A is connected to the second internal electrode 42 exposed from the second end surface 22B. The material of the first electrode 62A is the same as the material of the first electrode 61A in the first external electrode 61.

As illustrated in FIG. 3, the second electrode 62B covers the outer surface BD62A of the first electrode 62A. Details of the second electrode 62B will be described later. The third electrode 62C covers the outer surface BD62B of the second electrode 62B. A part of the third electrode 62C protrudes from the second electrode 62B. Although not illustrated in the drawing, the third electrode 62C has a two-layer structure of a nickel layer and a tin layer in this order from the second electrode 62B side.

The second external electrode 62 does not reach the first external electrode 61 on the side surface 22C, and is disposed away from the first external electrode 61 in the direction along the first axis X. On the side surface 22C of the base body 20, the first external electrode 61 and the second external electrode 62 are not stacked in a central portion in the direction along the first axis X. In FIGS. 1 to 3, the first external electrode 61 and the second external electrode 62 are indicated by two-dot chain lines.

### Second Electrode

The configuration of the second electrode 61B will be described. Hereinafter, the second electrode 61B of the first external electrode 61 will be representatively described, and the same applies to the second electrode 62B of the second external electrode 62.

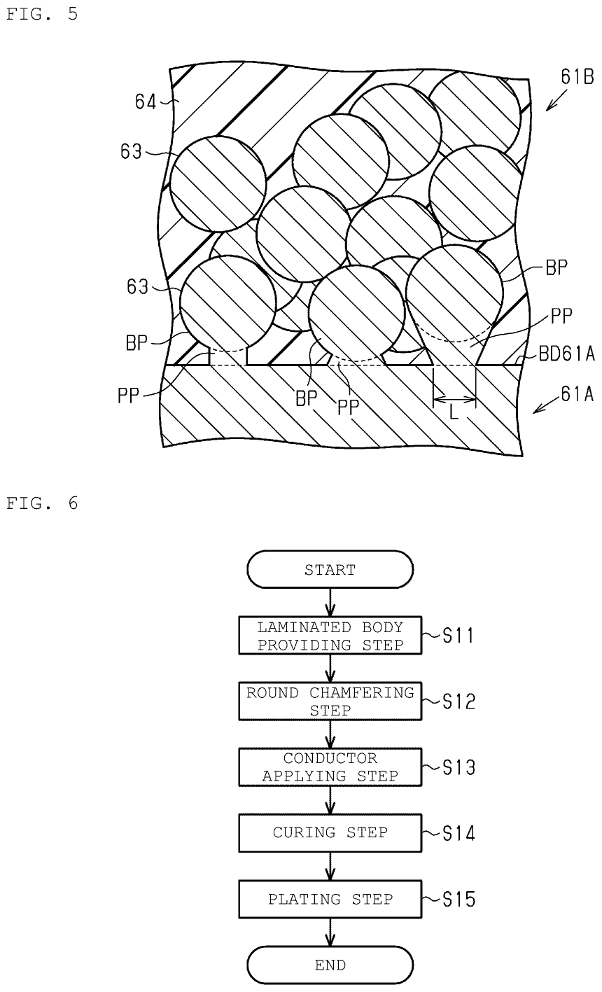

As illustrated in FIG. 5, the second electrode 61B is a sintered body containing copper. Specifically, the second electrode 61B contains the copper particles 63. In FIG. 5, only some of the copper particles 63 are denoted by reference numerals. In addition, each of the copper particles 63 is illustrated in a substantially circular shape, but may be elliptical or other amorphous particles.

The second electrode 61B contains a silicone resin 64 as a synthetic resin in addition to the copper particles 63. The silicone resin 64 contains Si. It is to be noted that the silicone resin 64 is a polymer composed of a siloxane bond and a Si—C bond. The silicone resin 64 is distributed in a mesh shape. Specifically, when the second electrode 61B is viewed in section, the silicone resin 64 is distributed in a mesh shape so as to fill the space between the plurality of copper particles 63.

As illustrated in FIG. 4, the average value of the thickness H of the second electrode 61B is about 700 nm. The thickness H of the second electrode 61B is the shortest distance from the outer surface BD61A of the first electrode 61A to the outer surface BD61B of the second electrode 61B. In FIG. 4, the thickness H at an arbitrary position is illustrated. The average value of the thickness H of the second electrode 61B is calculated as follows. First, an arbitrary section of the second electrode 61B is photographed with an electron microscope. Next, a range in a direction along the outer surface BD61B of the second electrode 61B is specified for the photographed image. In this range, the sectional area of the second electrode 61B is calculated by image processing for a measurement range of at least 5 μm or more. Then, the calculated sectional area of the second electrode 61B in the measurement range is divided by the length, which is the measurement range, to calculate the average value of the thickness H of the second electrode 61B.

The second electrode 61B contains a chemical component that is not contained in the second electrode 61B and is contained only in the first electrode 61A. Specifically, the chemical component is a glass component which is a constituent component of first electrode 61A. The glass component spreads over substantially the entire second electrode 61B.

The second electrode 61B contains a chemical component that is not contained in the second electrode 61B and is contained only in the third electrode 61C. Specifically, the chemical component is a nickel component which is a constituent component of the third electrode 61C. The nickel component may reach the first electrode 61A.

### Contact State Between First Electrode and Second Electrode

As illustrated in FIG. 5, it is assumed that the electronic component 10 is viewed in a specific section including the first electrode 61A and the second electrode 61B. The specific section is, for example, a section orthogonal to the central axis CA of the base body 20. At this time, the copper particles 63 of the second electrode 61B are in line contact with the outer surface BD61A of the first electrode 61A. In this contact portion, the copper particles 63 and the copper component of the first electrode 61A are integrated, and there may be no boundary between the two copper components. In a case where the boundary between the copper particles 63 and the first electrode 61A cannot be observed, a straight line connecting an end and the other end of a contact portion with the copper particles 63 is defined as the outer surface BD61A of the first electrode 61A.

The copper particles 63 in line contact with the outer surface BD61A of the first electrode 61A have a spherical portion BP and a columnar portion PP. The columnar portion PP extends from a portion of the spherical portion BP facing the first electrode 61A toward the first electrode 61A. This is because a part of the copper particles 63 is melted during the manufacturing process and integrated with the outer surface BD61A of the first electrode 61A.

In the specific section, the columnar portion PP has a substantially rectangular shape, a substantially trapezoidal shape in which the width increases toward the outer surface BD61A, or a substantially trapezoidal shape in which the width decreases toward the outer surface BD61A. Here, the maximum width of the columnar portion PP is smaller than the particle size of the spherical portion BP.

In the specific section, a contact length L between the copper particles 63 in line contact with the first electrode 61A and the first electrode 61A is 5 nm or more. The contact length L is measured as follows. First, in the specific section, the contours of the copper particles 63 and the outer surface BD61A of the first electrode 61A are acquired by image processing with an electron microscope. Then, the number of copper particles 63 in contact with the outer surface BD61A is counted within a range of continuous 50 nm or more on the outer surface BD61A. In addition, within the same range, the total value of the contact lengths L of the copper particles 63 in contact with the outer surface BD61A is measured. A value obtained by dividing the total value by the counted number of the copper particles 63 is defined as the contact length L with the first electrode 61A per one copper particle 63. In the measurement of the contact length L of the copper particles 63, it is preferable to measure the contact length L at two or more locations for each section in a plurality of sections, for example, five or more sections for one electronic component 10, and to set the average value of the measured values as the final contact length L of the copper particles 63.

In the present exemplary embodiment, the average particle size of the copper particles 63 is 50 nm or more and 100 nm or less. The average particle size of the copper particles 63 is determined as follows. First, the contours of the copper particles 63 are acquired by image processing with an electron microscope. Then, the area of one copper particle 63 is calculated. Then, a circle having the calculated area is assumed. The diameter of the circle is calculated as the particle size of the copper particles 63. In this manner, the particle size is calculated for ten or more copper particles 63, and the average value thereof is taken as the average particle size. As described above, in the present exemplary embodiment, the contact length L of the copper particles 63 with respect to the outer surface BD61A of the first electrode 61A is 10 nm or more. In the present exemplary embodiment, the contact length L of the copper particles 63 with the first electrode 61A is 10% or more of the average particle size of the copper particles 63.

### Method of Manufacturing Electronic Component

Next, the method for manufacturing the electronic component 10 will be described.

As illustrated in FIG. 6, the method for manufacturing the electronic component 10 includes a laminated body providing step S11, a round chamfering step S12, a conductor applying step S13, a curing step S14, and a plating step S15.

First, in forming the base body 20, a laminate body is prepared in the laminated body providing step S11. Since the laminate body at this stage is in a state before round chamfering, the laminate body has a rectangular parallelepiped shape having the six planes. Specifically, for example, first, a plurality of ceramic sheets to be the base body 20 is prepared. Each of the sheets has a thin plate shape. A conductive paste to be the first internal electrode 41 is laminated on the sheet. A ceramic sheet to be the base body 20 is laminated on the paste. A conductive paste to be the second internal electrode 42 is laminated on the sheet. In this manner, the ceramic sheet and the conductive paste are alternately laminated. Then, the laminated sheets are subjected to pressure bonding in the stacking direction by means such as die pressing. Thereafter, the sheets subjected to the pressure bonding are cut into a predetermined size to form an unfired laminated body. Thereafter, the unfired laminated body is fired at a high temperature to provide a laminated body.

Next, the round chamfering step S12 is performed. In the round chamfering step S12, the laminate body provided in the laminated body providing step S11 is round chamfered. By this step, the base body 20 in which the corner portion is round chamfered is obtained.

Next, the conductor applying step S13 is performed. In the conductor applying step S13, the first conductor paste is applied to a part of the first end surface 22A of the base body 20 and a part of the second end surface 22B of the base body 20 by an immersion method. Specifically, the first conductor paste is applied so as to cover the entire region of the first end surface 22A and parts of the four side surfaces 22C. In addition, the first conductor paste is applied so as to cover the entire region of the second end surface 22B and parts of the four side surfaces 22C. The first conductor paste contains a copper component and a silicon component.

Further, in the conductor applying step S13, the second conductor paste is applied onto the first conductor paste at two positions. The second conductor paste is a complex ink. The second conductor paste is prepared as follows. First, an amine compound such as 2-ethylhexylamine and an alcoholamine such as 2-amino-2-methylpropanol are mixed. Then, a silicon component such as a silicone resin is added thereto in an amount of 0.001-10 wt % with respect to the weight of Cu alone. Then, a metal salt is further added thereto and dissolved to prepare the second conductor paste. The sintering onset temperature of the copper component is 170 degrees, and the curing onset temperature of the silicon component is 250 degrees.

Next, the curing step S14 is performed. Specifically, in the curing step S14, the base body 20 with the first conductor paste and the second conductor paste applied thereto is heated. According to the present exemplary embodiment, the base body 20 with the first conductor paste and the second conductor paste applied thereto is heated in a nitrogen atmosphere. Then, the temperature is maintained within the range from 300 degrees to 600 degrees. As a result, the first conductor paste and the second conductor paste are fired. In firing the second conductor paste, first, sintering of the copper component contained in the second electrode 61B and in the second electrode 62B is started. At the time when the copper component is started to be sintered, the silicon component is not cured with fluidity. Thus, the gaps of the copper component are filled with the silicon component. Then, when the temperature is further increased to the curing onset temperature of the silicon component after the copper component is started to be sintered, the silicon component contained in the second electrode 61B and in the second electrode 62B is started to be cured. More specifically, the curing onset temperature of the silicon component is higher than the sintering onset temperature of the copper component. Then, the copper component is sintered, thereby producing the copper particles 63. In addition, the silicon component is cured, thereby producing the silicone resin 64. In addition, as described above, the curing onset temperature of the silicon component is higher than the sintering onset temperature of the copper component, thus providing the silicone resin 64 in the network form, which fills the gaps between the copper particles 63. As a result, the second electrode 61B and the second electrode 62B as described above are formed.

In the curing step S14, the copper component contained in the second conductor paste has high surface free energy. Therefore, the copper component contained in the second conductor paste is sucked onto the copper component contained in the first conductor paste so as to reduce the surface area. As a result, in the specific section, the copper particles 63 are in line contact with the first electrode 61A.

Next, the plating step S15 is performed. Electroplating is performed at a position where the second electrode 61B and the second electrode 62B are located. As a result, the third electrode 61C is formed on the surface of the second electrode 61B. In addition, the third electrode 62C is formed on the surface of the second electrode 62B. Although not illustrated in the in the drawing, the third electrode 61C and the third electrode 62C are electroplated with two kinds of nickel and tin to form a two-layer structure. In this way, the electronic component 10 is formed.

### Advantageous Effects of Present Embodiment

The advantageous effects of the present exemplary embodiment will be described. Hereinafter, the effects of the first external electrode 61 will be representatively described, and the second external electrode 62 also produces the same advantageous effects.

(1) According to the configuration mentioned above, since the first external electrode 61 does not contain a silver component, migration can be suppressed from occurring in the first external electrode 61. In addition, since the second electrode 61B contains the copper particles 63, some of the copper particles 63 fall off when an external force acts on the second electrode 61B. Therefore, the possibility that the entire second electrode 61B is peeled off from the first electrode 61A is low. In addition, In a case where there is a possibility that all the copper particles 63 fall off when an external force acts on the second electrode 61B, there is a possibility that electrical connection cannot be established between the second electrode 61B and the first electrode 61A. On the other hand, since the copper particles 63 are in line contact with the outer surface BD61A of the first electrode 61A, excellent conductivity can be secured between the first electrode 61A and the second electrode 61B. According to the configuration mentioned above, it is possible to realize appropriate characteristics as an external electrode capable of securing suitable mechanical strength and suitable conductivity while suppressing migration.

(2) In the exemplary embodiment mentioned above, the contact length L between the copper particles 63 in line contact with the first electrode 61A and the first electrode 61A in the specific section is 5 nm or more. Since the copper particles 63 are in line contact with the first electrode 61A with the dimensions as described above, the second electrode 61B is less likely to be peeled off from the first electrode 61A.

(3) In the exemplary embodiment mentioned above, the contact length L between the copper particle 63 in linear contact with the first electrode 61A and the first electrode 61A in the specific section is 10% or more of the average particle size of the copper particle 63. Since the copper particles 63 are in line contact with the first electrode 61A with such dimensions, the copper particles 63 are hardly peeled off from the first electrode 61A, and the fixing force of the second electrode 61B to the first electrode 61A is secured.

(4) In the exemplary embodiment mentioned above, the second electrode 61B contains the silicone resin 64 as a synthetic resin. That is, the synthetic resin contained in the second electrode 61B contains Si. When the synthetic resin contains Si, the surface tension of the synthetic resin is more likely to be retained between the copper particles 63 during production. As a result, in the formed second electrode 61B, the synthetic resin becomes a dense film that fills the gaps between the copper particles 63. As a result, the barrier property of the second electrode 61B is improved.

(5) In the exemplary embodiment mentioned above, the second electrode 61B contains a chemical component that is not contained in the second electrode 61B and is contained only in the first electrode 61A. According to such a configuration, a structure in which at least a part of the second electrode 61B is integrated with the first electrode 61A is obtained. As a result, the second electrode 61B is less likely to be peeled off from the first electrode 61A.

The second electrode 61B contains a chemical component that is not contained in the second electrode 61B and is contained only in the third electrode 61C. According to such a configuration, a structure in which at least a part of the second electrode 61B is integrated with the third electrode 61C is obtained. As a result, the third electrode 61C is less likely to be peeled off from the second electrode 61B.

(6) In the exemplary embodiment mentioned above, the first electrode 61A contains a copper component. According to this configuration, the copper particles 63 contained in the second electrode 61B are more likely to be integrated with the copper component contained in the first electrode 61A in the manufacturing process. Therefore, since many copper particles 63 are in line contact with the first electrode 61A, improvement of the fixing force of the second electrode 61B to the first electrode 61A can be expected.

### Modification Examples

The exemplary embodiment mentioned above and the following modification examples can be implemented in combination within a range that is not technically contradictory. In the case of a modification that can be commonly applied to the first external electrode 61 and the second external electrode 62, a modification related to the first external electrode 61 will be representatively described.
In the exemplary embodiment mentioned above, the electronic component 10 is not limited to any multilayer ceramic capacitor. For example, the electronic component 10 may be a piezoelectric component, a thermistor, an inductor, or the like.
In the exemplary embodiment mentioned above, the material of the base body 20 may be a dielectric substance, a piezoelectric substance, a magnetic substance such as ferrite, a composite of a synthetic resin and a metal, or the like.
The shape of the base body 20 is not limited to the example of the exemplary embodiment. For example, the base body 20 may have a polygonal columnar shape, other than a quadrangular columnar shape, having a central axis CA. Furthermore, the base body 20 may be the core of a wire-wound inductor component. For example, the core may have what is called a drum core shape. Specifically, the core may have a columnar winding core portion and a flange portion provided at each end of the winding core portion.
Of the outer surface 21 of the base body 20, a boundary portion between the adjacent planes may not have a chamfered shape. In this case, there is no curved surface at the boundary portion.
The shapes of the first internal electrode 41 and the second internal electrode 42 are not limited as long as they can ensure electrical conduction with the corresponding first external electrode 61 and second external electrode 62. The number of the first internal electrodes 41 and the second internal electrodes 42 is not limited, and may be smaller or larger than 4.
In the exemplary embodiment mentioned above, the material of the first electrode 61A is not limited to the example of the exemplary embodiment mentioned above. That is, the first electrode 61A may not contain a copper component. For example, the material of the first electrode 61A may be a metal such as Ni, Pd, or Au, or may include any of these metals.
In the exemplary embodiment mentioned above, the second electrode 61B may cover at least a part of the first electrode 61A.
In the exemplary embodiment mentioned above, the average value of the thickness H of the second electrode 61B is not limited to the example of the exemplary embodiment mentioned above. The entire thickness of the first external electrode 61 including the second electrode 61B may be designed in consideration of mechanical strength and the like required for the electronic component 10.
In the exemplary embodiment mentioned above, the configuration related to the third electrode 61C in the first external electrode 61 may be omitted. The material of the third electrode 61C is not limited to the example of the exemplary embodiment mentioned above. For example, the third electrode 61C may be made of only nickel, or made of only tin, or may contain other materials other than silver.
In the exemplary embodiment mentioned above, the synthetic resin is not limited to the silicone resin 64. For example, the synthetic resin may be a synthetic resin containing Si such as a silicone oligomer. The synthetic resin contained in the second electrode 61B may contain N. For example, the synthetic resin may be a synthetic resin containing N such as urethane, epoxy, polyimide, polyimide amide, or polyamide. As described above, in a case where the synthetic resin contains N, the heat resistance of the second electrode 61B is improved.

In addition, the synthetic resin is not limited to a resin containing N and Si, and may be a resin such as acrylic, alkyd, or polyester, or may be another synthetic resin. In the second electrode 61B, a composite of these N-containing synthetic resins, Si-containing synthetic resins, and other synthetic resins may be adopted as the synthetic resin. In the second electrode 61B, one kind of synthetic resin containing Si and N may be adopted as the synthetic resin.
In the exemplary embodiment mentioned above, the contact length L between the copper particles 63 in line contact with the first electrode 61A and the first electrode 61A is not limited to the example of the exemplary embodiment mentioned above. For example, in the specific section, the contact length L between the copper particles 63 in line contact with the first electrode 61A and the first electrode 61A may be less than 5 nm as long as electrical conduction with the first electrode 61A is secured. Similarly, in the specific section, the contact length L between the copper particles 63 in line contact with the first electrode 61A and the first electrode 61A may be less than 10% of the average particle size of the copper particles 63. In the exemplary embodiment mentioned above, the average particle size of the copper particles 63 is also not limited to the example of the exemplary embodiment mentioned above.
In the exemplary embodiment mentioned above, the second electrode 61B may not contain a chemical component that is not contained in the second electrode 61B and is contained only in the first electrode 61A. That is, the boundary between the second electrode 61B and the first electrode 61A may be clearly separated. In addition, the second electrode 61B may not contain a chemical component that is not contained in the second electrode 61B and is contained only in the third electrode 61C. That is, the boundary between the second electrode 61B and the third electrode 61C may be clearly separated.
The manufacturing process of the electronic component 10 in the exemplary embodiment mentioned above is not limited to the example of the exemplary embodiment mentioned above. For example, the base body 20 may be subjected to processing such as physical polishing.
In the exemplary embodiment mentioned above, the method for applying the first conductor paste and the second conductor paste is not limited to the example of the exemplary embodiment mentioned above. For example, these pastes may be applied by printing, or may be applied by an inkjet method or the like. In addition, the first conductor paste and the second conductor paste may have different methods.
In the exemplary embodiment mentioned above, the curing step S14 may be performed more than one time. More specifically, the firing may be performed more than one time.
In the exemplary embodiment mentioned above, the sintering onset temperature of the copper component of the second conductor paste and the curing onset temperature of the silicon component thereof are not limited to the example of the exemplary embodiment mentioned above.
In the exemplary embodiment mentioned above, the second conductor paste may be nano inks. In the case of nano inks, the inks are prepared as follows. Nanometal powders are dispersed in solvents containing cellosolves, carbitols, hydrocarbons, aromatics, and the like. Then, various silicone-modified resins, or silicone resins, sol-gel-based materials, or the like are added in an amount of 0.001-10 wt % with respect to the weight of Cu alone. The second conductor paste of the nano inks may be prepared in this manner, or by different methods.
In the exemplary embodiment mentioned above, the materials in the case of a complex ink for the second conductor paste is not limited to the example of the exemplary embodiment mentioned above. For example, the amine compound may be any of primary amines, secondary amines, and tertiary amines, and furthermore, the number of N atoms is not limited. For example, the amine compound may be a primary amine such as an octylamine or a hexylamine, a secondary amine such as a di-n-butylamine, or a tertiary amine such as an N,N-dimethylhexylamine. In addition, the amine compound may be an alcoholamine, a diamine, or the like, and the positional relationship between the N atom and the OH group is not specified at the α-, β-, γ-position, or the like. Furthermore, the numbers of N and O atoms in one molecule are also not particularly limited. For example, the amine compound may be an α-hydroxylamine such as 2-dimethylaminoethanol or 2-ethylaminoethanol, or a β-hydroxylamine such as 3-amino-1-propanol or 4-amino-2-butanol. Furthermore, the amine compound may be a diamine such as an ethylenediamine, or a cyclic diamine such as piperazine. In addition, the silicon component may be, for example, various silicone-modified resins such as epoxy resins, polyester resins, and phenol resins, sol-gel materials, and the like. In addition, as the metal salt, metal salts obtained from formic acids, acetic acids, oxalic acids, other organic acids, and the like may be adopted. Examples of this type of metal salt include a copper formate anhydride.
In the exemplary embodiment mentioned above, the electronic component 10 may include a glass film. In such a case, for example, the glass film may be formed so as to cover the region of a part of the outer surface 21 of the base body 20. More specifically, the electrical connection between the first internal electrodes 41 and the first external electrode 61 and the electrical connection between the second internal electrodes 42 and the second external electrode 62 have only to be secured, if there is any glass film covering the base body 20.

### Supplementary Note

Technical ideas that can be derived from the exemplary embodiments and modification examples mentioned above will be described below.
[1] An electronic component including: a base body; an internal electrode located inside the base body; and
   an external electrode covering a part of an outer surface of the base body and containing no silver component, wherein the external electrode includes: a first electrode covering a part of an outer surface of the base body and connected to the internal electrode; and a second electrode covering an outer surface of the first electrode, the second electrode contains a copper particle and a synthetic resin, and when viewed in a specific section including the first electrode and the second electrode, the copper particle of the second electrode is in line contact with an outer surface of the first electrode.
[2] The electronic component according to [1], wherein a contact length of the copper particle in line contact with the first electrode with respect to the first electrode in the specific section is 5 nm or more.
[3] The electronic component according to [1] or [2],wherein a contact length of the copper particle in line contact with the first electrode with respect to the first electrode in the specific section is 10% or more of an average particle size of the copper particle.
[4] The electronic component according to any one of [1] to [3], wherein the synthetic resin contained in the second electrode contains Si.
[5] The electronic component according to any one of [1] to [4], wherein the synthetic resin contained in the second electrode contains N.

[6] The electronic component according to any one of [1] to [5], wherein the external electrode further includes a third electrode covering an outer surface of the second electrode, the second electrode contains a chemical component that is not contained in the second electrode and is contained only in the first electrode, and the second electrode contains a chemical component that is not contained in the second electrode and is contained only in the third electrode.

[7] The electronic component according to any one of [1] to [6], wherein the first electrode contains a copper component.

### DESCRIPTION OF REFERENCE SYMBOLS

10: Electronic component
20: Base body
21: Outer surface
41: First internal electrode
42: Second internal electrode
61: First external electrode
61A: First electrode
61B: Second electrode
61C: Third electrode
63: Copper particle
64: Silicone resin

1. An electronic component comprising:
a base body;
an internal electrode located inside the base body; and
an external electrode covering a part of an outer surface of the base body and including no silver component, wherein
the external electrode includes: a first electrode configured to cover a part of an outer surface of the base body and connected to the internal electrode; and a second electrode configured to cover an outer surface of the first electrode,
the second electrode includes a copper particle and a synthetic resin, and
when viewed in a specific section including the first electrode and the second electrode, the copper particle of the second electrode is in line contact with an outer surface of the first electrode.

2. The electronic component according to claim 1, wherein a contact length of the copper particle in line contact with the first electrode with respect to the first electrode in the specific section is 5 nm or more.

3. The electronic component according to claim 1, wherein a contact length of the copper particle in line contact with the first electrode with respect to the first electrode in the specific section is 10% or more of an average particle size of the copper particle.

4. The electronic component according to claim 2, wherein a contact length of the copper particle in line contact with the first electrode with respect to the first electrode in the specific section is 10% or more of an average particle size of the copper particle.

5. The electronic component according to claim 1, wherein the synthetic resin included in the second electrode includes Si.

6. The electronic component according to claim 2, wherein the synthetic resin included in the second electrode includes Si.

7. The electronic component according to claim 3, wherein the synthetic resin included in the second electrode includes Si.

8. The electronic component according to claim 1, wherein the synthetic resin included in the second electrode includes N.

9. The electronic component according to claim 2, wherein the synthetic resin included in the second electrode includes N.

10. The electronic component according to claim 3, wherein the synthetic resin included in the second electrode includes N.

11. The electronic component according to claim 1, wherein the external electrode further includes a third electrode configured to cover an outer surface of the second electrode, the second electrode includes a chemical component that is not included in the second electrode and is contained only in the first electrode, and the second electrode includes a chemical component that is not included in the second electrode and is included only in the third electrode.

12. The electronic component according to claim 2, wherein the external electrode further includes a third electrode configured to cover an outer surface of the second electrode, the second electrode includes a chemical component that is not contained in the second electrode and is included only in the first electrode, and the second electrode includes a chemical component that is not included in the second electrode and is included only in the third electrode.

13. The electronic component according to claim 3, wherein the external electrode further includes a third electrode configured to cover an outer surface of the second electrode, the second electrode includes a chemical component that is not contained in the second electrode and is included only in the first electrode, and the second electrode includes a chemical component that is not included in the second electrode and is included only in the third electrode.

14. The electronic component according to claim 4, wherein the external electrode further includes a third electrode configured to cover an outer surface of the second electrode, the second electrode includes a chemical component that is not contained in the second electrode and is included only in the first electrode, and the second electrode includes a chemical component that is not included in the second electrode and is included only in the third electrode.

15. The electronic component according to claim 5, wherein the external electrode further includes a third electrode configured to cover an outer surface of the second electrode, the second electrode includes a chemical component that is not contained in the second electrode and is included only in the first electrode, and the second electrode includes a chemical component that is not included in the second electrode and is included only in the third electrode.

16. The electronic component according to claim 1, wherein the first electrode includes a copper component.

17. The electronic component according to claim 2, wherein the first electrode includes a copper component.

18. The electronic component according to claim 3, wherein the first electrode includes a copper component.

19. The electronic component according to claim 4, wherein the first electrode includes a copper component.

20. The electronic component according to claim 5, wherein the first electrode includes a copper component.
